(19) United States
(12) Patent Application Publication
(10) Pub. No.: US 2021/0046905 A1
(43) Pub. Date: Feb. 18, 2021

(54) WIPER ARM DEVICE

(71) Applicant: Robert Bosch GmbH, Stuttgart (DE)

(72) Inventors: Alan Pfetzer, Buehl (DE); Godelieve Kraemer, Huegelsheim (DE)

(21) Appl. No.: 16/994,854

(22) Filed: Aug. 17, 2020

(30) Foreign Application Priority Data
Aug. 15, 2019 (DE) 102019212229.9

(51) Int. Cl. B60S 1/52

(52) U.S. Cl. CPC B60S 1/522

(57) ABSTRACT

A wiper arm device with at least one wiper arm (12), with at least one hose unit (14) which is arranged at least partially on the wiper arm (12) and comprises at least one fluid feed hose (16) and at least one wiper arm (18). The wiper arm device has at least one connecting unit (20) which fluidically connects the at least one fluid feed hose (16) and the at least one wiper arm hose (18) and which connects the at least one fluid feed hose (16) and the at least one wiper arm hose (18) to the at least one wiper arm (12), in particular is fixed thereon.

### BACKGROUND OF THE INVENTION

A wiper arm device has already been proposed with at least one wiper arm, with at least one hose unit which is arranged at least partially on the wiper arm and comprises at least one fluid feed hose and at least one wiper arm hose.

### SUMMARY OF THE INVENTION

The invention is based on a wiper arm device with at least one wiper arm, with at least one hose unit which is arranged at least partially on the wiper arm and comprises at least one fluid feed hose and at least one wiper arm hose.

It is proposed that the wiper arm device has at least one connecting unit which fluidically connects the at least one fluid feed hose and the at least one wiper arm hose and which connects the at least one fluid feed hose and the at least one wiper arm hose to the at least one wiper arm, in particular is fixed thereon.

A wiper arm device is at least a part, preferably a subassembly, of a glass pane wiper. The wiper arm device can preferably also comprise the whole glass pane wiper. The wiper arm device is preferably provided for use on a vehicle. The wiper arm device is preferably provided for moving a wiper blade for the purpose of cleaning a surface, preferably a glass pane on a vehicle. The wiper arm device is preferably coupled to a vehicle, in particular to the wiper blade of a vehicle, for the purpose of cleaning a vehicle glass pane. The wiper arm preferably has a wiper side on which the at least one wiper blade can be connected to the wiper arm and/or which is provided in order to form a connection with the at least one wiper blade. “Provided” should preferably be understood to mean specifically configured, specifically designed, and/or specifically equipped. That an object is provided for a certain function should preferably be understood to mean that the object fulfills and/or performs this certain function in at least one application and/or operating state.

The wiper arm device preferably comprises at least one fluid feed hose which is provided to pass a fluid, in particular wiper fluid, at least partially from a fluid tank to the wiper arm. The at least one fluid feed hose is preferably designed differently from the at least one wiper arm hose. The at least one fluid feed hose runs at least essentially parallel to the at least one wiper arm hose at least in a region in which the gap between the at least one fluid feed hose and the at least one wiper arm device is no more than 5 cm. The at least one fluid feed hose preferably runs along a region of the wiper arm which differs from a region of the wiper arm along which the at least one wiper arm hose runs. The at least one wiper arm hose preferably runs along no more than 25% of a maximum extent of the wiper arm along a main axis of extent of the wiper arm. The wiper arm device preferably comprises at least one wiper arm hose which is provided to pass a fluid, in particular wiper fluid, at least partially from the fluid feed hose along the wiper arm. A fluid hose, in particular the at least one fluid feed hose and/or the at least one wiper arm hose, is preferably at least one duct-like recess and/or at least one duct delimited by a hose-like and/or at least one tubular element, wherein the duct-like recess and/or the duct delimited by a hose-like and/or tubular element is provided for the passage of the fluid, preferably the wiper fluid. The at least one fluid feed hose and/or the at least one wiper arm hose are preferably at least partially and preferably mostly formed by at least one hose. The at least one fluid feed hose and the at least one wiper arm hose preferably together at least partially form the hose unit. The hose unit preferably extends over at least 50%, preferably over at least 80%, of a maximum extent of the wiper arm along a main axis of extent of the wiper arm. The hose unit preferably extends along at least 50%, preferably over at least 80%, of a maximum extent of the wiper arm along a main axis of extent of the wiper arm. A main axis of extent of an object is preferably an axis which runs parallel to a longest edge of a smallest rectangular solid which only just encloses the object.

The at least one connecting unit preferably connects the at least one hose unit to the at least one wiper arm on the wiper side of the at least one wiper arm. The wiper side of the at least one wiper arm preferably has a drive interface. The at least one wiper arm can preferably be connected to a wiper drive via the drive interface. The at least one hose unit is preferably connected to the at least one connecting unit along a fluid connection axis of the at least one connecting unit. The fluid connection axis preferably runs at least essentially parallel to the main axis of extent of the at least one wiper arm. “Essentially parallel” should preferably be understood to mean an orientation of a direction relative to a reference direction, in particular within a plane, wherein the direction has a deviation relative to the reference direction which is in particular less than 8°, advantageously less than 5°, and particularly advantageously less than 2°. The at least one wiper arm is preferably connected to the at least one connecting unit along an arm connection axis of the at least one connecting unit. The arm connection axis preferably runs at least essentially perpendicular to the main axis of extent of the at least one wiper arm. The at least one connecting unit is preferably connected to the at least one wiper arm at two points, in particular at opposite sides of the at least one connecting unit, in particular of the at least one wiper arm. The at least one connecting unit is preferably connected to the at least one hose unit at two points, in particular at opposite sides of the at least one connecting unit. The at least one connecting unit is preferably connected to the at least one fluid feed hose at one side of the at least one connecting unit which is opposite the side at which the at least one connecting unit is connected to the at least one wiper arm hose. The at least one connecting unit is preferably designed in an at least essentially mirror-symmetrical fashion in order to be fixed on at least one wiper arm and to be connected to the at least one fluid feed hose and the at least one wiper arm hose. The at least one connecting unit preferably has at least two mirror planes. A first mirror plane preferably has a surface normal which is oriented at least essentially parallel to the main axis of extent of the at least one wiper arm. A further mirror plane preferably has a surface normal which is oriented at least essentially perpendicular to the main axis of extent of the at least one wiper arm. The first mirror plane is preferably oriented perpendicular to the further mirror plane. The at least one hose unit is preferably connected to the at least one connecting unit, in the neighborhood of at least 1 cm over the at least one connecting unit, with a minimum gap of at least 0.3 cm from the at least one wiper arm.

The at least one wiper arm preferably comprises at least one holding unit, in particular for holding and/or connecting to the at least one connecting unit. The holding unit is preferably arranged on the wiper side of the wiper arm. The at least one holding unit preferably has at least one, preferably at least two, recesses. The recesses are preferably provided to hold the at least one connecting unit in at least one position. The at least one wiper arm preferably has at least one, preferably at least two, rib elements. The at least one wiper arm preferably has at least two rib elements which are arranged in particular laterally offset on at least one wiper arm. The at least two rib elements are preferably arranged offset on the at least one wiper arm along the main axis of extent of the at least one wiper arm. The at least two rib elements are preferably arranged on the wiper side of the wiper arm, on different sides perpendicular to the main axis of extent of the wiper arm. The at least two rib elements preferably delimit the at least two recesses in the direction of the main axis of extent of the wiper arm. The at least two rib elements preferably delimit the holding unit in each case partially in the direction of the man extent axis of the wiper arm. The at least one connecting unit is preferably provided for a precise connection to the at least two recesses of the at least one holding unit and/or the at least two rib elements. The at least one connecting unit is preferably arranged in a coupled state at least partially in the holding unit, in particular in the recesses. The at least one connecting unit is preferably arranged in a coupled state with the at least one wiper arm at least partially between the at least two rib elements.

An advantageously efficient connection of the hose unit to the wiper arm can be achieved by virtue of the embodiment of the wiper arm device according to the invention. It can advantageously be achieved that the hose is led over a short distance on the wiper arm. An advantageously versatile connecting unit can be achieved. A connecting unit can in particular be achieved which interconnects at least two part-units of the hose unit and fixes them to the wiper arm. An advantageously unrestricted flow of fluid through the hose unit can be achieved in spite of the connection to the wiper arm.

It is furthermore proposed that the at least one connecting unit is arranged, in particular fastened, on the at least one wiper arm in a region close to a movement axis of the at least one wiper arm. The at least one wiper arm preferably has at least two movement axes. The at least two movement axes are preferably arranged so that they are at least essentially perpendicular to each other. The at least one first movement axis is preferably arranged at one end of a maximum extent of the at least one wiper arm along its main axis of extent. The at least one wiper arm is preferably mounted on a further object, preferably the vehicle, so that it can pivot at the at least one first movement axis. At least one further movement axis of the at least one wiper arm is preferably arranged in a region, preferably a central region, of the at least one wiper arm, which is spaced apart from one end of a maximum extent of the at least one wiper arm along the main axis of extent. A part of the at least one wiper arm is preferably mounted so that it can pivot at the at least one further movement axis with respect to another part of the at least one wiper arm. A region close to a movement axis is preferably a region of the at least one wiper arm which is spaced apart from one of the at least two movement axes of the at least one wiper arm by no more than 10 cm. The at least one connecting element is preferably arranged in a region of the wiper arm between the at least one first movement axis and the at least one further movement axis. It is conceivable that the wiper arm has at least one further movement axis at which the wiper arm is mounted so that it can move at least partially, in particular so that it can pivot. The at least one wiper arm is preferably arranged in a region close to the at least one first movement axis and/or the at least one further movement axis. It can be achieved that the hose unit is advantageously secured in a region close to a movement axis of the hose unit with the wiper arm. It can be achieved that it is advantageously secured at at least one movement axis in a material-saving fashion.

It is additionally proposed that the at least one connecting unit has at least two connecting pieces which delimit at least one fluid duct of the at least one connecting unit which is provided for connection to the at least one fluid feed hose and the at least one wiper arm hose. The at least one connecting unit preferably delimits a fluid duct. The at least one fluid duct preferably runs at least essentially parallel to the main axis of extent of the at least one wiper arm. The at least two connecting pieces preferably extend at least essentially parallel to the main axis of extent of the at least one wiper arm. The at least two connecting pieces preferably have a maximum extent which is oriented at least essentially parallel to the main extent of the at least one wiper arm. The maximum extent of the at least two connecting pieces is particularly preferably at least essentially parallel to a main extent of the region of the at least one wiper arm between the at least two movement axes of the at least one wiper arm. The fluid duct preferably runs through the at least two connecting pieces. The at least two connecting pieces are preferably arranged on opposite sides of the at least one connecting unit, preferably at least essentially parallel to the main axis of extent of the wiper arm. The at least two connecting pieces are preferably designed, and in particular dimensioned, in a similar fashion to each other. An advantageously symmetrical connection of the fluid feed hose and the wiper arm hose can be achieved.

It is furthermore proposed that the at least one connecting unit forms a snap-fit connection to the at least one wiper arm in at least one operating state. The at least one connecting unit is preferably provided for a snap-fit connection to the at least one wiper arm. In at least one operating state, the at least one connecting unit preferably forms a snap-fit connection to the at least one holding unit, in particular to the at least one recess of the at least one holding unit, of the at least one wiper arm. In at least one operating state, the at least one connecting element preferably snaps in between two retaining ribs on the wiper arm, in particular is connected to the at least one wiper arm by a snap-fit connection. The at least one connecting element preferably forms a snap-fit connection axis to the at least one wiper arm which is oriented at least essentially perpendicular to the at least two connecting pieces. An advantageously reversible connection of the at least one connecting element to the at least one wiper arm can be achieved. The advantageous ability of the at least one connecting unit to be connected quickly to the at least one wiper arm can be achieved.

It is furthermore proposed that the at least one connecting unit has at least two fixing elements on which at least one fixing projection is arranged in each case and which, in at least one operating state, form a snap-fit connection to the at least one wiper arm. The at least two fixing elements are preferably provided for the purpose of connection to the at least two recesses of the at least one holding unit. The at least two fixing projections preferably each have at least one insertion chamfer. The at least two fixing projections are preferably provided for the purpose of a snap-fit connection in and/or on the at least one holding unit, in particular the at least one recess of the at least one holding unit. The at least two recesses of the at least one holding unit of the at least one wiper arm preferably have insertion chamfers for centering the connecting element. An advantageous spacing, in particular an advantageous gap, of the connection of the connecting element to the hose unit from the connection of the connecting element to the wiper arm can be achieved.

It is furthermore proposed that the at least one connecting unit has at least two, in particular the abovementioned, fixing elements which are arranged on different sides of at least one connection nozzle of the connecting unit. The at least two fixing elements are preferably arranged on different outer sides of at least one connection nozzle of the connecting unit and are arranged at least essentially perpendicular to the main axis of extent of the at least one connection nozzle. The at least two fixing elements are preferably integrally formed with the at least one connection nozzle. “Integrally” should preferably be understood to mean bonded such as, for example, as a result of a welding process and/or gluing process etc, and particularly advantageously molded on such as as a result of being manufactured by casting and/or manufactured in a one-or multi-component injection-molding process. The at least two fixing elements can preferably be connected to the at least one wiper arm along the arm connection axis, in particular are connected in at least one operating state. The at least two fixing elements are preferably arranged on the sides along the arm connection axis on the at least one connection nozzle. An advantageously stable connection of the at least one connecting element to the wiper arm perpendicular to the connection of the at least one connecting element to the at least one hose unit can be achieved. An advantageous orientation of connecting forces of the connection of the at least one connecting element to the wiper arm and the connection of the at least one connecting element to the at least one hose unit can be achieved. An advantageous assembly and/or disassembly of a connection of the connecting unit to the wiper arm or the hose unit can be achieved, wherein assembly or disassembly of the respective other connection can advantageously be omitted.

It is furthermore proposed that the at least one connecting unit delimits at least one fluid duct which has a minimum flow cross-section which is at least as great as a smallest flow cross-section of the hose unit. The at least one fluid feed hose and the at least one wiper arm hose preferably have the same minimum flow cross-section, up to a maximum deviation of 25%, calculated in particular on the basis of the area. The fluid duct of the at least one connecting unit preferably has a flow cross-section which is preferably at least 3% greater than the smaller flow cross-section of the at least one fluid feed hose and the at least one wiper arm hose. The at least one fluid duct of the at least one connecting unit preferably has a constant flow cross-section. Crushing of the hose unit in spite of the hose unit being fixed on the wiper arm can in particular be prevented. An advantageously large, in particular a sufficient fluid flow rate can be achieved and in particular ensured.

A wiper system is moreover proposed with at least one wiper blade and with at least one wiper arm device. The at least one wiper blade preferably comprises at least one wind deflector unit. The at least one wiper blade preferably comprises at least one wiper strip unit on which at least one wiper lip is arranged. The at least one wiper blade preferably comprises at least one spring bar. The at least one wiper blade preferably comprises at least one wiper blade end cap.

It is intended that the wiper arm device according to the invention and/or the wiper system according to the invention is/are hereby not limited to the above-described application and embodiment. In particular, the wiper arm device according to the invention and/or the wiper system according to the invention can have a number of individual elements, components, and units which differs from the number mentioned herein in order to fulfill a function described herein. In addition, in the case of the value ranges stated in this document, values that lie within the said limits should also be considered as being disclosed and capable of being used in any fashion.

### BRIEF DESCRIPTION OF THE DRAWINGS

Further advantages result from the following description of the drawings. An exemplary embodiment of the invention is shown in the drawings. The drawings, the description, and the claims contain numerous features in combination. A person skilled in the art will expediently both consider the features individually and combine them to make appropriate further combinations.

In the drawings:

FIG. 1 shows a wiper system according to the invention in a schematic view,

FIG. 2 shows a connecting unit of a wiper arm device according to the invention in a schematic view,

FIGS. 3a and 3b show a wiper arm and a connecting unit of a wiper arm device according to the invention in a schematic view, and

FIG. 4 shows a wiper arm and a connecting unit of a wiper arm device according to the invention in a schematic view.

### DETAILED DESCRIPTION

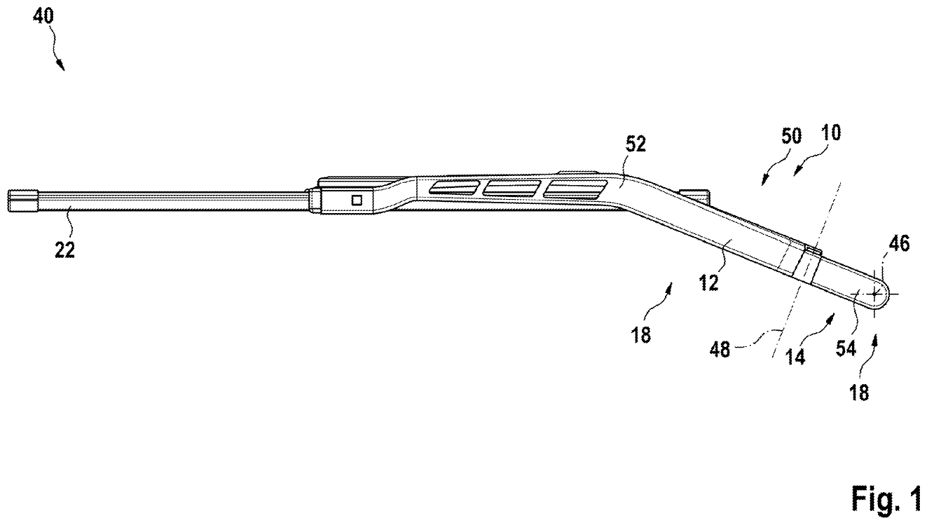

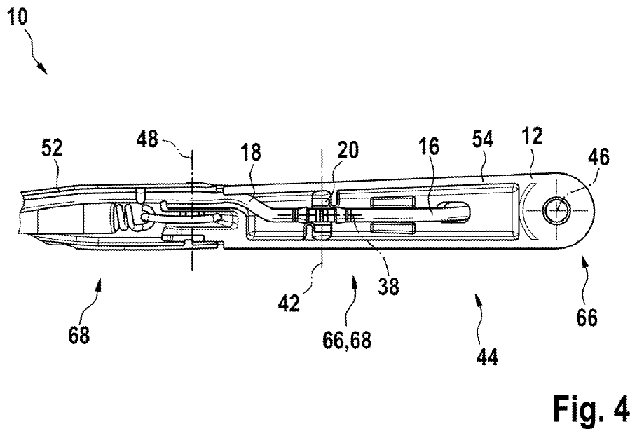

FIG. 1 shows a wiper system 40. The wiper system 40 comprises at least one wiper arm device 10. The wiper arm device 10 comprises at least one wiper arm 12. The wiper arm device 10 comprises at least one hose unit 14 arranged at least partially on the wiper arm 12. The wiper system 40 comprises at least one wiper blade 22. The wiper blade 22 is connected, in particular rigidly, to a wiper arm 12 of the wiper arm device 10. A hose unit 14 is arranged on the wiper arm 12, in particular a wiper side 44 of the wiper arm 12 (FIG. 4). The hose unit 14 comprises at least one fluid feed hose 16. The hose unit 14 comprises at least one wiper arm hose 18.

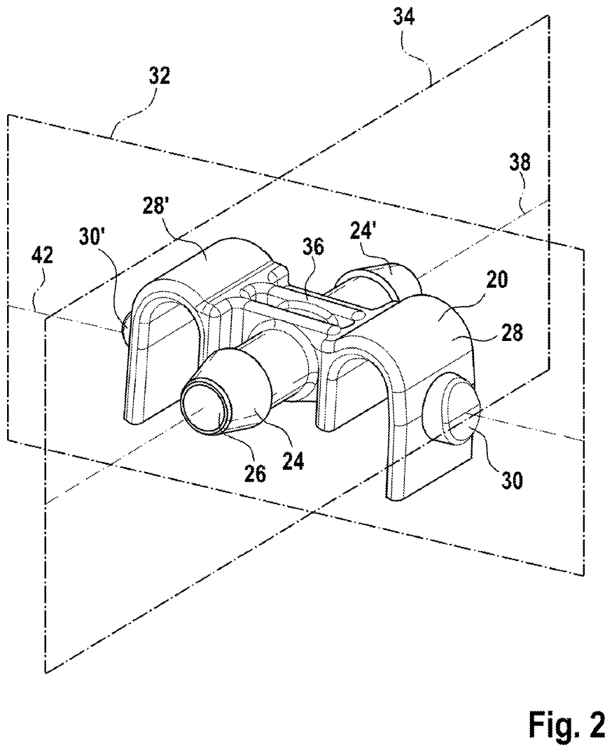

FIG. 2 shows a connecting unit 20. The at least one connecting unit 20 has at least two connecting pieces 24, 24′. The at least one connecting unit 20 has at least two fixing elements 28, 28′. At least one fixing projection 30, 30′ is arranged on each of the fixing elements 28, 28′. The at least two connecting pieces 24, 24′ are arranged opposite each other. The at least two connecting pieces 24, 24′ are situated opposite each other along a fluid connection axis 38. The fluid connection axis 38 is in particular oriented parallel to a shortest distance between the connecting pieces 24, 24′. The at least one connecting unit 20 has at least two fixing elements 28, 28′ which are arranged on different sides of at least one connection nozzle 24, 24′ of the connecting unit 20. The at least two fixing projections 30, 30′ are arranged opposite each other. The fixing projections 30, 30′ have fixing insertion chamfers. The at least two fixing elements 28, 28′ are situated opposite each other along an arm connection axis 42. The arm connection axis 42 is oriented in particular parallel to a shortest distance between the fixing elements 28, 28′, in particular perpendicular to the fluid connection axis 38. The connecting unit 20 is designed in a mirror-symmetrical fashion. The connecting pieces 24, 24′ are in particular arranged on the connecting unit 20 in a mirror-symmetrical fashion, in particular with respect to a mirror plane 32 which is oriented parallel to a shortest distance between the fixing elements 28, 28′. The fixing elements 28, 28′ are in particular arranged on the connecting unit 20 in a mirror-symmetrical fashion, in particular with respect to a mirror plane 34 which is oriented parallel to a shortest distance between the connecting pieces 24, 24′. The connecting unit 20 has a central element 36 to which the fixing elements 28, 28′ and the at least two connecting pieces 24, 24′ are connected, in particular integrally. The central element 36 at least partially encloses the at least two connecting pieces 24, 24′ to form a connection to the at least two connecting pieces 24, 24′. The at least two fixing elements 28, 28′ are designed so that they at least essentially have a curved shape.

The at least two connecting pieces 24, 24′ delimit at least one fluid duct 26 of the at least one connecting unit 20. The at least one connecting unit 20 delimits at least one fluid duct 26 which has a minimum flow cross-section which is at least as great as a smallest flow cross-section of the hose unit 14. The fluid duct 26 is provided in order to be connected to the at least one fluid feed hose 16 and to the at least one wiper arm hose 18.

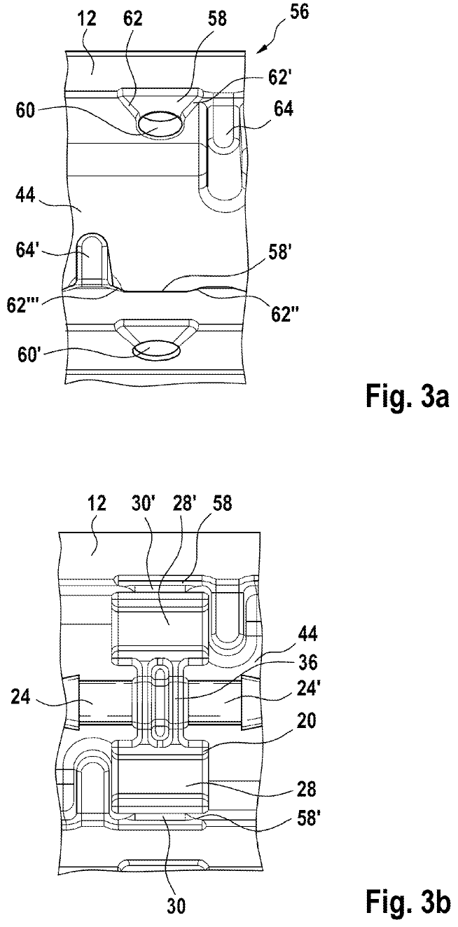

FIG. 3a shows that the at least one wiper arm 12 comprises at least one holding unit 56. The holding unit 56 is provided in particular for holding and/or connection to the at least one connecting unit 20. The holding unit 56 is arranged on the wiper side 44 of the wiper arm 12. The at least one holding unit 56 has two recesses 58, 58′. The recesses 58, 58′ each have a round part-recess 60 with insertion chamfers 62, 62′, 62″, 62′″ leading to the round part-recess 60. The recesses 58, 58′ are provided in order to hold the at least one connecting unit 20 in precisely one position (FIG. 3b). The at least one wiper arm 12 has two rib elements 64, 64′. The rib elements 64, 64′ are arranged laterally offset on the wiper arm 12, in particular in the direction of the main axis of extent of the wiper arm 12. The at least two rib elements 64, 64′ are arranged on different sides, in particular opposite sides of the wiper arm 12. The at least two rib elements 64, 64′ are arranged on edges of the two recesses 58, 58′. One rib element 64, 64′ is in each case arranged on each recess 58, 58′. The rib elements 64, 64′ are arranged on different sides of the recesses 58, 58′ in the direction of the main axis of extent of the wiper arm 12.

FIG. 4 shows that the wiper arm device 10 comprises at least one connecting unit 20 which fluidically connects the fluid feed hose 16 and the at least one wiper arm hose 18. The connecting unit 20 connects the at least one fluid feed hose 16 and the at least one wiper arm hose 18 to the at least one wiper arm 12. The connecting unit 20 fixes the at least one fluid feed hose 16 and the at least one wiper arm hose 18 to the at least one wiper arm 12.

The wiper arm 12 has at least two movement axes 46, 48. The at least two movement axes 46, 48 are arranged perpendicularly to each other. A first movement axis 46 is arranged at one end of a maximum extent of the at least one wiper arm 12 along its main axis of extent. A close region 66, in particular of the wiper arm 12, is arranged about the first movement axis 46. The at least one wiper arm 12 is mounted, so that it can pivot at the at least one first movement axis 46, on a further object, preferably a vehicle. A further movement axis 48 of the at least one wiper arm 12 is arranged in a region, preferably a central region 50, of the at least one wiper arm 12, which region is spaced apart from one end of a maximum extent of the at least one wiper arm 12 along the main axis of extent by at least 5 cm. A close region 68, in particular of the wiper arm 12, is arranged about the further movement axis 48. A wiper arm part 52 of the at least one wiper arm 12 is mounted so that it can pivot at the at least one further movement axis 48 with respect to a wiper arm part 54 of the at least one wiper arm 12. The at least one connecting unit 20 is arranged on the at least one wiper arm 12, in a region 66, 68 close to a movement axis 46, 48 of the at least one wiper arm 12. The at least one connecting unit 20 is fastened to the at least one wiper arm 12 in a region 66, 68 close to a movement axis 46, 48 of the at least one wiper arm 12. The at least one connecting unit 20 is arranged and/or fastened on the at least one wiper arm 12 in a close region 66, 68 of two movement axes 46, 48 of the at least one wiper arm 12.

The at least one connecting unit 20 forms a snap-fit connection to the at least one wiper arm 12 in at least one operating state. The at least two fixing elements 30, 30′ form a snap-fit connection to the at least one wiper arm 12 in at least one operating state. The at least one hose unit 14 is connected to the at least one connecting unit 20 along the fluid connection axis 38 of the at least one connecting unit 20. The at least one wiper arm 12 is connected to the at least one connecting unit 20 along the arm connection axis 42 of the at least one connecting unit 20.

1. A wiper arm device comprising
at least one wiper arm (12),
at least one hose unit (14) which is arranged at least partially on the wiper arm (12) and comprises at least one fluid feed hose (16) and at least one wiper arm hose (18), and
at least one connecting unit (20) which fluidically connects the at least one fluid feed hose (16) and the at least one wiper arm hose (18) and which connects the at least one fluid feed hose (16) and the at least one wiper arm hose (18) to the at least one wiper arm (12).

2. The wiper arm device according to claim 1, characterized in that the at least one connecting unit (20) is arranged on the at least one wiper arm (12) in a region (66, 68) close to a movement axis (46, 48) of the at least one wiper arm (12).

3. The wiper arm device according to claim 1, characterized in that the at least one connecting unit (20) has at least two connecting pieces (24, 24′) which delimit at least one fluid duct (26) of the at least one connecting unit (20), the fluid duct being configured for connection to the at least one fluid feed hose (16) and the at least one wiper arm hose (18).

4. The wiper arm device according to claim 1, characterized in that the at least one connecting unit (20) forms a snap-fit connection to the at least one wiper arm (12) in at least one operating state.

5. The wiper arm device according to claim 1, characterized in that the at least one connecting unit (20) has at least two fixing elements (28, 28′) on which at least one fixing projection (30, 30′) is arranged in each case and which, in at least one operating state, form a snap-fit connection to the at least one wiper arm (12).

6. The wiper arm device according to claim 1, characterized in that the at least one connecting unit (20) has at least two fixing elements (28, 28′) which are arranged on different sides of at least one connection nozzle (24, 24′) of the connecting unit (20).

7. The wiper arm device according to claim 1, characterized in that the at least one connecting unit (20) delimits at least one fluid duct (26) which has a minimum flow cross-section which is at least as great as a smallest flow cross-section of the hose unit (14).

8. The wiper arm device according to claim 1, wherein the at least one connecting unit (20) is fixed on the at least one wiper arm (12).

9. The wiper arm device according to claim 8, characterized in that the at least one connecting unit (20) is fastened on the at least one wiper arm (12) in a region (66, 68) close to a movement axis (46, 48) of the at least one wiper arm (12).

10. A wiper system with at least one wiper blade (22) and with at least one wiper arm device (10) according to claim 1.
